(19) United States
(12) Patent Application Publication
(10) Pub. No.: US 2004/0008106 A1
(43) Pub. Date: Jan. 15, 2004

(54) Deceleration-activated safety light

(76) Inventor: Michael T. Konczal, Plano, TX (US)

Correspondence Address: Michael T. Konczal, P.O. Box 863656, Plano, TX, 75088, US

(21) Appl. No.: 10/609,101

(22) Filed: Jun. 30, 2003

Related U.S. Application Data
(60) Provisional application No. 60/394,430, filed on Jul. 9, 2002.

(51) Int. Cl. B62J 3/00

(52) U.S. Cl. 340/432; 340/467

(57) ABSTRACT

The invention provides a safety light activated by deceleration independent of the application of a brake lever. In general, the invention described provides a self-contained circuit for sensing deceleration and activating a light emitter responsive to the deceleration. In a disclosed specific embodiment of the invention, a helmet for motorcycle riders and like applications includes a circuit including a light emitter on a rearward portion of the helmet. Deceleration-responsive switching means is coupled to the light emitter and a suitable power source.

### PRIORITY DATE

This application claims the benefit of U.S. Provisional Application No. 06/394,430, filed Jul. 9, 2002.

### TECHNICAL FIELD

The invention relates to apparatus and methods for providing a safety or brake light activated by vehicle deceleration rather than the application of brakes per se. More particularly, the invention relates to motorcycle safety helmets having safety lights responsive to deceleration.

### BACKGROUND OF THE INVENTION

It has been known to endeavor to enhance safety by alerting drivers that nearby vehicles are applying their brakes. In order to increase brake light visibility on automobiles, third brake lights have been added to automobiles at locations elevated above than the traditional bumper-mounted or body-mounted twin brake lights.

It is known to equip motorcycles with brake lights operated on the same principle as that used for automobiles. That is, the brake light is included in a circuit designed to activate the light when the vehicle brake lever is engaged by the operator. One problem with attempting to provide elevated-location brake lights to motorcycles is that the vehicle typically has no such location for mounting the light. Attempts to provide supplemental lighting to motorcycle helmets are also hampered by dependence on wire connections and/or coupling to the motorcycle electrical system for power and/or control. Another problem encountered by motorcyclists is that, due to their smaller mass, motorcycles decelerate much more rapidly than automobiles. Motorcyclists are often able to coast to a slow speed or even a complete stop without using the brakes. Thus, a traditional brake lever activated light is not activated, and following motorists are not alerted to the deceleration, sometimes causing the motorcyclist to be rear-ended by an inattentive motorist.

Due to these and other problems, it would be desirable to provide a safety light circuit for use by motorcyclists that is adaptable to locating at an elevation higher than offered by the motorcycle itself, and that may be activated by deceleration, rather than a mechanical brake lever switch.

### SUMMARY OF THE INVENTION

In general, the invention described provides a self-contained circuit means for sensing deceleration and activating a light emitter responsive to deceleration.

According to a preferred embodiment of the invention, a helmet for motorcycle riders and like applications includes a circuit including light emitting means on a rearward portion of the helmet. Switching means responsive to deceleration is coupled to the light emitting means and a suitable power source.

According to another aspect of the invention, motorcycle helmet safety light system includes a motorcycle helmet equipped with a light circuit responsive to deceleration and a self-contained power source.

According to a further aspect of the invention, a motorcycle helmet safety light system also includes means for recharging the self-contained power source.

According to yet another aspect of the invention, a light-activating sensor circuit in a helmet is responsive to deceleration exceeding about 0.005 g.

The invention provides technological advantages including but not limited to providing a safety light independent of wire connections to a vehicle for power or switching. The invention provides further advantages in terms of safety by indicating deceleration first hand, rather than relying on an incidental factor such as the engagement of a brake lever.

### BRIEF DESCRIPTION OF THE DRAWINGS

For a better understanding of the invention including its features, advantages and specific embodiments, reference is made to the following detailed description along with accompanying drawings in which:

FIG. 1 is a block diagram illustrating an example of a preferred embodiment of a motorcycle helmet according to the invention; and

FIG. 2 is a schematic diagram of an example of a circuit according to the invention.

References in the detailed description correspond to like references in the figures unless otherwise noted. Like numerals refer to like parts throughout the various figures. The descriptive and directional terms used in the written description such as top, bottom, left, right, etc., refer to the drawings themselves as laid out on the paper and not to physical limitations of the invention unless specifically noted. The drawings are not to scale and some features of embodiments shown and discussed are simplified or exaggerated for illustrating the principles of the invention.

### DETAILED DESCRIPTION OF PREFERRED EMBODIMENTS

While the making and using of various embodiments of the present invention are discussed in detail below, it should be appreciated that the present invention provides various applicable inventive concepts which can be embodied in a wide variety of specific contexts. It should be understood that the invention may be practiced with vehicles, helmets, and circuitry of various types and applications without altering the principles of the invention.

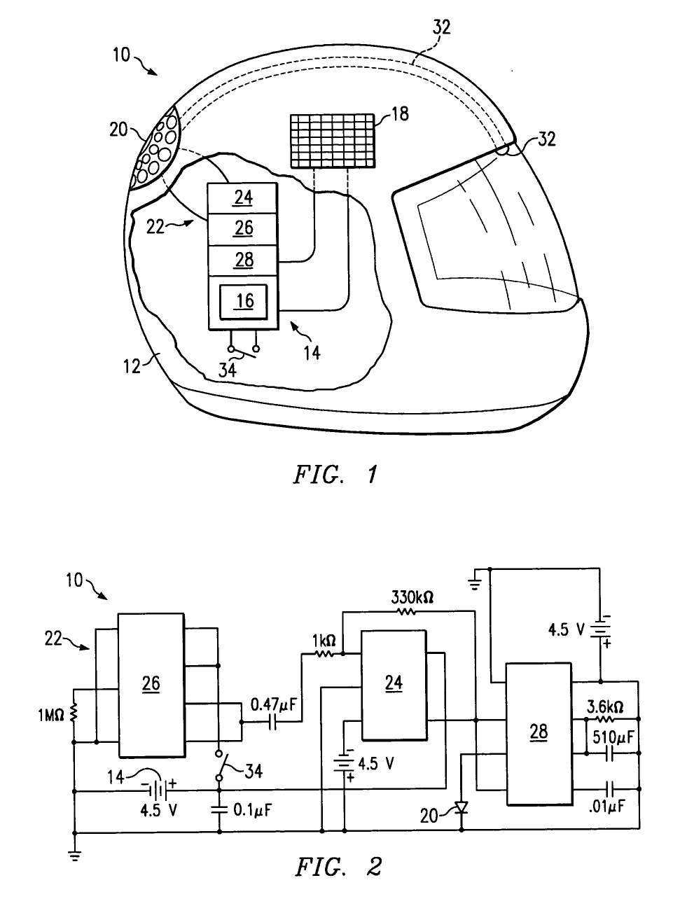

Representatively illustrated in FIG. 1, an example of a circuit 10 of the invention is shown affixed to a motorcycle helmet 12. The circuit 10 includes a power source 14. Preferably, the power source 14 has a direct current (DC) battery 16 sufficient for providing current for the remainder of the circuit 10. The power source 14 may also include a photovoltaic (PV) cell 18 or array for charging the battery 16. A light emitter 20, preferably an array of light emitting diodes (LEDs), is electrically coupled to the power source 14. A sensor portion 22 of the circuit 10 is electrically coupled to the power source 14 and the light emitter 20. Preferably, the sensor portion 22 includes logic 24 capable of accepting input from a sensor 26 such as an accelerometer. Preferably, the sensor portion 22 is capable of sensing and using deceleration inputs encountered in normal vehicular operation. Preferably, deceleration sensitivity on the order of about 0.005 g may be used.

In operation, the circuit 10 is responsive to deceleration such when deceleration is sensed by the sensor 26, the logic 24 filters out spurious signals or noise, the sensor portion 22 acts as a switch and activates the light emitter 20. Preferably, the circuit 10 includes a delay 28 for keeping the light emitter 20 switched “on” for a predetermined period after deceleration is sensed. For example, a delay of 0.5 seconds may be used.

Now referring primarily to FIG. 2, an example schematic diagram of a circuit 10 according to the invention is shown. It should be understood that this is but one example of a circuit constructed in accordance with the concept of the invention and that alternative implementations are possible using substitute components and alternative configurations without departure from the invention.

The sensor portion 22 of the circuit 10, preferably includes at least one accelerometer 26 and is configured to be responsive to the deceleration of the circuit 10 along the primary direction of intended travel, in this case the longitudinal axis. For example, an ADXL202 accelerometer, commercially available from Analog Devices, Norwood Mass., may be used. One or more reference accelerometers may also be included in the circuit for detecting and filtering decelerations that might otherwise adversely influence the responsiveness of the circuit 10 to deceleration in other directions, such as, for example, those on a more or less vertical axis, perhaps resulting from a user's vehicle encountering bumps in the road. The sensor portion 22 of the circuit 10 activates the light source 20 upon sensing deceleration along the longitudinal axis resulting from negative acceleration in the travel of the circuit 10. Typically, a brief delay is introduced in the circuit by a delaying mechanism 28 in order to permit processing of the deceleration signal by the logic 24 and to keep the light source 20 illuminated for a predetermined length of time. The delay should be calculated to smooth over any relatively brief fluctuations in the primary axis deceleration. It should be appreciated that, while many alternative configurations of the circuit 10 are possible, the invention provides a light activated by deceleration independent of the application of a brake lever. Thus, the use of the invention is independent of the circuitry of vehicle with which it is used.

In its preferred embodiments, the invention has a means of transmitting to the user that the deceleration-activated light is being activated. Preferably, this is accomplished with a fiber-optic transmission line 32 from the light source 20 to a location viewable by the user. A suitable wire connection and indicator light may alternatively be used.

It is also preferred that the invention include a photovoltaic or solar array 18 for recharging the battery 16 of the power source 14. The array 18 is preferably coupled to the battery 16 for recharging while the associated helmet 12 is in use, as well as when it is at rest. Preferably, the circuit 10 also includes a switch having a selectable “off” position to enable the user to deactivate the sensor portion 22 when the helmet 12 is not being worn. This prevents damage to the sensor portion 22 of the circuit 10 in the event the helmet 12 is dropped while being carried or stored.

The embodiments shown and described above are only exemplary. Even though numerous characteristics and advantages of the present invention have been set forth in the foregoing description together with details of the method and device of the invention, the disclosure is illustrative only and changes may be made within the principles of the invention to the full extent indicated by the broad general meaning of the terms used in the attached claims.

I claim:

1. In a helmet for motorcycle riders and like applications, a circuit comprising:
light emitting means disposed on a rearward portion of the helmet;
switching means responsive to deceleration operably coupled to the light emitting means; and
a power source operably coupled with the light emitting means and the switching means.

2. A circuit according to claim 1 wherein the switching means further comprises a circuit adapted for sensing deceleration.

3. A circuit according to claim 1 wherein the switching means further comprises at least one accelerometer adapted to sense deceleration.

4. A circuit according to claim 1 wherein the switching means further comprises at least one primary axis accelerometer and at least one reference axis accelerometer.

5. A circuit according to claim 1 wherein the power source further comprises a battery.

6. A circuit according to claim 1 wherein the power source further comprises a photovoltaic cell.

7. A circuit according to claim 1 further comprising light transmitting means extending through the helmet from the light emitting means to a position at the periphery of a forward portion of the helmet.

8. A circuit according to claim 1 wherein the light emitting means further comprises a plurality of light emitting diodes.

9. A circuit comprising:
a sensor portion adapted for sensing deceleration;
a light emitter portion for emitting light
a logic portion operably coupling the sensor portion and the light emitting portion for switching the light emitting portion based upon selected input from the sensor portion.

10. A circuit according to claim 9 wherein the circuit is affixed to headwear.

11. A circuit according to claim 9 wherein the circuit is affixed to a motorcycle helmet.

12. A circuit according to claim 9 wherein the circuit is affixed to a bicycle helmet.

13. A circuit according to claim 9 wherein the sensor portion is responsive to deceleration exceeding about 0.005 g.

14. A circuit according to claim 9 wherein the sensor portion further comprises at least one accelerometer adapted to sense deceleration.

15. A circuit according to claim 9 wherein the sensor portion further comprises at least one primary axis accelerometer and at least one reference axis accelerometer.

16. A motorcycle helmet safety light system comprising:
a motorcycle helmet further comprising;
a light circuit responsive to deceleration mounted on a rearward portion of the helmet; and
a self-contained power source affixed to the helmet and operably coupled to the light circuit.

17. A motorcycle helmet safety light system according to claim 16 further comprising means for recharging the self-contained power source.

18. A motorcycle helmet safety light system according to claim 16 further comprising photovoltaic means for recharging the self-contained power source.

19. A motorcycle helmet safety light system according to claim 16 wherein the light circuit further comprises at least one accelerometer.

20. A motorcycle helmet safety light system according to claim 16 wherein the light circuit further comprises at least one primary axis accelerometer and at least one reference axis accelerometer.
